(19) United States
(12) Patent Application Publication
(10) Pub. No.: US 2015/0250190 A1
(43) Pub. Date: Sep. 10, 2015

(54) CRISPY FOODSTUFF WITH SOFT PORTION

(71) Applicant: INTERCONTINENTAL GREAT BRANDS LLC, East Hanover, NJ (US)

(72) Inventors: Vani Vemulapalli, East Hanover, NJ (US); Jan Karwowski, East Hanover, NJ (US); Edward C. Coleman, East Hanover, NJ (US)

(73) Assignee: Intercontinental Great Brands LLC, East Hanover, NJ (US)

(21) Appl. No.: 14/440,671

(22) PCT Filed: Nov. 4, 2013
(86) PCT No.: PCT/US13/68291

§ 371 Date: May 5, 2015

Related U.S. Application Data
(60) Provisional application No. 61/722,543, filed on Nov. 5, 2012.

(51) Int. Cl. A21D 13/00; A21D 6/00; A21D 8/02

(52) U.S. Cl. CPC A21D 13/0022; A21D 8/025; A21D 6/003; A21D 13/0038

(57) ABSTRACT

Compositions and methods related to a baked dough-based component based on a pre-baked heat-treated flour, the baked dough-based component having a first fat concentration and a crispy texture; and a baked fat-based component in direct contact with the baked dough-based component, having a second fat concentration that is higher than the first fat concentration, the baked fat-based component having a soft texture; wherein the foodstuff exhibits a dual texture comprising a crispy texture of the dough-based component and a soft texture of the fat-based component, and wherein the dual texture is maintained throughout the shelf life of the foodstuff.

### BACKGROUND OF THE INVENTION

The present invention generally relates to food products that have a dual texture. It is desirable to develop a food product that has a first texture that is crispy or both crispy and crunchy and a second texture that is soft and/or creamy. It is also desirable that such a product retain its dual texture characteristics even after a long shelf life period. Such products are difficult to achieve in certain baked goods because, for example, fat migration from a soft and/or creamy portion (such as a fat-based filling) to an outer shell crispy portion (e.g., a dough-based casing) has a tendency to reduce the creaminess of the filling and the crispness of the outer shell and degrade the dual texture qualities of the product.

### BRIEF SUMMARY OF THE INVENTION

According to some embodiments of the present invention, a method for producing a dual-textured foodstuff includes admixing ingredients such as flour and water to form a slurry; exposing the slurry to heat at conditions sufficient to produce a gelatinized dough; adding a fat-based component to the dough to form a prebaked foodstuff; and baking the prebaked foodstuff to obtain a foodstuff having a dual texture. The dual texture may include a baked, fat-based component having a soft texture and a baked dough-based component having a crispy texture.

In some embodiments, the slurry may be heated by steam, which may be injected into the slurry. The steam may have a temperature of about 212° F., and may be injected for about 10 minutes to about 20 minutes. In some embodiments, the slurry is exposed to heat sufficient to produce about 90% to about 100% gelatinization of the flour.

In some embodiments, additional ingredients are mixed with the gelatinized dough before adding the fat-based component. Such ingredients may include a starch, such as potato starch or pregelatinized corn starch, sugar, leavening, or processing aid.

The dough may be configured to accept the fat-based component, for example, by sheeting the dough into at least two layers and adding the fat-based component between the sheeted dough layers. In other embodiments, the dough and the fat-based component may be extruded. Adding the fat-based component to the dough may entail placing the fat-based component in direct contact with the dough. In some embodiments, the fat-based component is completely enclosed within the baked dough-based component. In some embodiments, the foodstuff maintains the dual texture for at least 6 months after baking.

In some embodiments, the flour of the slurry comprises about 70 wt %, about 75 wt %, or about 80 wt % of the baked dough-based component. The dough-based component may include a fat content of less than 5 wt % of the dough-based component. The fat-based component may include a fat content of at least 40 wt %.

According to some embodiments of the present invention a method of producing a baked foodstuff includes forming a first dough layer having a first affinity for fat migration; forming a gelatinized dough-based fat migration-barrier layer including by admixing ingredients comprising flour and water to form a slurry and exposing the slurry to heat at conditions sufficient to transform the slurry to an at least partially gelatinized dough; assembling the foodstuff by positioning the gelatinized dough-based fat migration barrier layer between a first dough layer and an edible composition having a fat content that is greater than the fat content of the first dough layer; and baking the pre-baked food stuff to form a baked foodstuff.

According to some embodiments of the present invention, a dual-textured foodstuff includes a baked dough-based component based on a pre-baked heat-treated flour, and a baked fat-based component, wherein the foodstuff exhibits a dual texture throughout the shelf life of the foodstuff. The dual texture may include a crispy texture of the dough-based component and a soft texture of the fat-based component.

The baked fat-based component may be in direct contact with the baked dough-based component. In some embodiments, the fat-based component is completely enclosed by the dough-based component. In some embodiments, the baked dough-based component makes up about 45 wt % to about 90 wt % of the foodstuff, or about 60 wt % to about 75 wt % of the foodstuff. In certain embodiments, the fat-based component makes up about 10 wt % to about 55 wt % of the foodstuff, or about 25 wt % to about 40 wt % of the foodstuff. The dough-based component may, for example, be a cracker, while the fat-based component may be sweet or savory.

The dough-based component may have a first fat concentration, with the fat-based layer having a second fat concentration that is higher than the first fat concentration. In some embodiments, the first fat concentration is less than 10 wt % and the second fat concentration is greater than 40 wt %. The first and second fat concentration may each remain significantly constant throughout the shelf life of the foodstuff.

According to some embodiments of the present invention, a dual textured cooked foodstuff includes a crispy cooked dough-based portion based on a steam-treated slurry of water and flour; a cooked soft fat-based filling in direct contact with the cooked dough portion; and a fat gradient between the cooked soft fat-based filling and the crispy cooked dough-based portion that is approximately zero.

### BRIEF DESCRIPTION OF THE SEVERAL VIEWS OF THE DRAWINGS

The foregoing summary, as well as the following detailed description of certain embodiments of the food product will be better understood when read in conjunction with the following exemplary embodiments and the appended drawings.

FIG. 1 is a process flow diagram of an exemplary embodiment of the present invention.

FIGS. 2-5 are views of an exemplary embodiment of a baked foodstuff of the present invention.

### DETAILED DESCRIPTION OF THE INVENTION

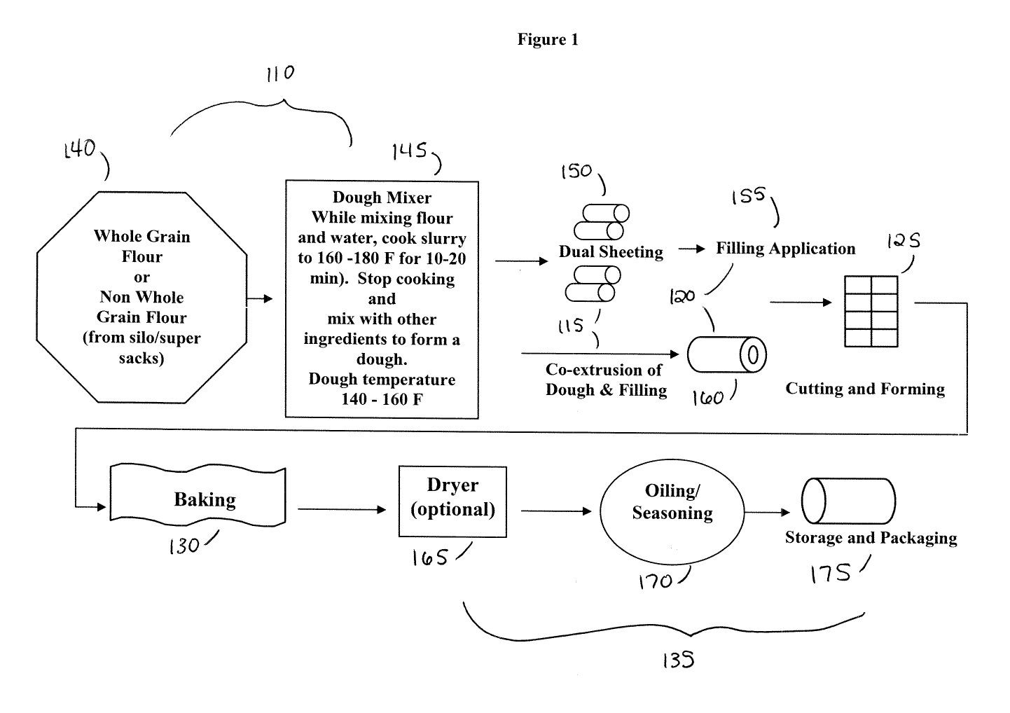

Referring to FIG. 1 in detail, the flow chart shows a general process scheme for making a dual-textured foodstuff, in accordance with an exemplary embodiment of the present invention. As illustrated, a dual-textured foodstuff may be produced by a method that includes: a) dough preparation 110; b) dough forming 115; c) filling addition or application 120; c) cutting and forming 125; d) baking 130; and e) finishing and/or packaging 135. In one embodiment, whole grain or non-whole grain flour 140 may be added to a dough mixer with water to create a slurry, and the slurry may be heated to a selected temperature (e.g., 160° F. to 180° F.) for a selected period of time (e.g., 10 minutes to 20 minutes) to gelatinize or at least partially gelatinize the flour 145. In one embodiment, additional ingredients may be added and mixed to the slurry or to the dough 145. In one embodiment, the dough may then be sheeted 150, followed by an application of filling 155, to create a prebaked foodstuff. The dough and filling may be coextruded to form a prebaked foodstuff 160. Next, the prebaked foodstuff may be cut and/or formed into a desired size and shape 125. The foodstuff may then be baked to form a multi-textured foodstuff 130. In one embodiment, the multi-textured food stuff includes a crispy and/or crunchy dough-based portion and a soft and/or creamy filling portion. After baking, the multi-textured snack may optionally be dried 165. Oil and/or seasoning may optionally be applied 170, followed by packaging and storage of the baked foodstuff 175.

One embodiment of the present invention relates to a shelf-stable, baked crispy and/or crunchy filled foodstuff. In one embodiment, the foodstuff has a soft, fat-based portion (e.g., a filling) and a crispy and/or crunchy dough-based portion (e.g., a casing). The foodstuff may maintain a multiple texture (e.g. a dual texture) for an extended period of time after cooking (e.g., baking, frying) and, in some embodiments, throughout the shelf life of the foodstuff. The foodstuff may be generally prepared by forming dough, adding a fat-based portion, such as a filling, to create a prebaked foodstuff, and baking to form the dual-textured foodstuff having a crispy dough-based portion and a soft fat-based portion. In some embodiments, the dough is prepared by heating ingredients such as flour and water to a gelatinization temperature, prior to baking. In some embodiments, the gelatinized dough is admixed with further ingredients before adding a fat-based portion.

In one embodiment, the foodstuff includes a dough-based portion (e.g., a casing or a layer) that is not receptive to fat migration from an adjoining fat-based portion (e.g., a fat-based filling). The resulting foodstuff may be characterized as having a crispy and/or crunchy texture from the dough-based portion and a creamy texture from the fat-based portion even after baking. Moreover, the exemplary food stuff preferably retains this dual texture feature for an extended period of time after baking (e.g., the shelf-life of the product).

In one embodiment, fat migration between the fat-based portion and the dough-based portion is substantially eliminated for at least 1 month of shelf-life. In one embodiment, fat migration between the fat-based portion and the dough-based portion is substantially eliminated for at least 2 months of shelf-life. In one embodiment, fat migration between the fat-based portion and the dough-based portion is substantially eliminated for at least 3 months of shelf-life. In one embodiment, fat migration between the fat-based portion and the dough-based portion is substantially eliminated for at least 4 months of shelf-life. In one embodiment, fat migration between the fat-based portion and the dough-based portion is substantially eliminated for at least 5 months of shelf-life. In one embodiment, fat migration between the fat-based portion and the dough-based portion is substantially eliminated for at least 6 months of shelf-life. In one embodiment, fat migration between the fat-based portion and the dough-based portion is substantially eliminated for at least 1 year of shelf-life.

The baked food product may include a casing that includes or is formed from the dough-based portion. In food products that include such a casing, the dough-based portion may be formed to at least partially and in some instances, completely or substantially completely, surround a fat based portion.

An exemplary baked food product may also include a barrier layer (e.g., a fat migration barrier layer) that includes or is formed from the dough-based portion. In some embodiments, the dough-based portion is formed into a fat migration barrier. In some embodiments, the dough-based portion is formed into a moisture migration barrier. In some embodiments, the dough-based portion is formed into both a fat migration barrier and a moisture migration barrier. In food products that include such a barrier layer, the barrier layer may be positioned between a layer that is more receptive to fat migration and/or moisture migration and a fat-based and/or moisture-based composition (e.g. a fat-based filling and/or a moisture based filling).

In some embodiments, the inclusion of fat migration inclusions such may enhance the fat and/or oil migration barrier functionality. In some embodiments, the fat migration inclusions are soluble. In some embodiments, the fat migration inclusions are insoluble. For example, fat migration inclusions including soluble and/or insoluble fibers may be added to a dough-based portion to enhance the fat migration barrier properties of the dough-based portion. Insoluble fat migration inclusions such as fibers, including corn, oat, and/or soy, may be added at levels of about 5 wt % to about 10 wt % of the pre-cooked dough-based portion; about 10 wt % of the pre-cooked dough-based portion; about 9 wt % of the pre-cooked dough-based portion; about 8 wt % of the pre-cooked dough-based portion; about 7 wt % of the pre-cooked dough-based portion; about 6 wt % of the pre-cooked dough-based portion; or about 5 wt % of the pre-cooked dough-based portion. In some embodiments, insoluble fibers include large surface areas which may absorb free fat and/or oil and thereby enhance the fat and/or oil migration barrier properties of the dough-based portion.

Soluble fat migration inclusions such as soluble fibers, including inulin, fructooligosaccharides, and/or resistant starches, may be added at levels of about 5 wt % to about 20 wt % of the pre-cooked dough-based portion; about 20 wt % of the pre-cooked dough-based portion; about 19 wt % of the pre-cooked dough-based portion; about 18 wt % of the pre-cooked dough-based portion; about 17 wt % of the pre-cooked dough-based portion; about 16 wt % of the pre-cooked dough-based portion; about 15 wt % of the pre-cooked dough-based portion; about 14 wt % of the pre-cooked dough-based portion; about 13 wt % of the pre-cooked dough-based portion; about 12 wt % of the pre-cooked dough-based portion; about 11 wt % of the pre-cooked dough-based portion; about 10 wt % of the pre-cooked dough-based portion; about 9 wt % of the pre-cooked dough-based portion; about 8 wt % of the pre-cooked dough-based portion; about 7 wt % of the pre-cooked dough-based portion; about 6 wt % of the pre-cooked dough-based portion; or about 5 wt % of the pre-cooked dough-based portion.

In some embodiments, low levels of flow agents, such as silicon dioxide and/or microcrystalline cellulose, may be added at levels of about 1 wt % or less of the pre-cooked dough-based portion. Such flow agents may have very large surface areas which may absorb free fat and/or oil and thereby enhance the fat and/or oil migration barrier properties of the dough-based portion. Certain soy and milk proteins may be added to the pre-cooked dough-based portion to enhance fat and/or oil migration barrier properties.

Dough-based portions having enhanced moisture barrier properties may be desirable, for instance, in products having a fat-based portion or a filling portion that is not fat-based with a water activity of about 0.5 or greater. In some embodiments, moisture barrier inclusions such as proteins, fats and/or polyols may be added to the dough-based portion to enhance the moisture migration barrier properties of the dough-based portion. Inclusion of whey protein concentrates or isolates, soy protein concentrates, and/or corn zein in the dough-based portion may enhance the formation of a hydrophobic barrier layer, thereby reducing migration of moisture between layers and/or portions of the product. Moisture barrier inclusions such as whey protein concentrates and isolates, soy protein concentrates, and/or corn zein may be added in an amount of about 5 wt % to about 20 wt % of the pre-cooked dough-based portion; about 20 wt % of the pre-cooked dough-based portion; about 19 wt % of the pre-cooked dough-based portion; about 18 wt % of the pre-cooked dough-based portion; about 17 wt % of the pre-cooked dough-based portion; about 16 wt % of the pre-cooked dough-based portion; about 15 wt % of the pre-cooked dough-based portion; about 14 wt % of the pre-cooked dough-based portion; about 13 wt % of the pre-cooked dough-based portion; about 12 wt % of the pre-cooked dough-based portion; about 11 wt % of the pre-cooked dough-based portion; about 10 wt % of the pre-cooked dough-based portion; about 9 wt % of the pre-cooked dough-based portion; about 8 wt % of the pre-cooked dough-based portion; about 7 wt % of the pre-cooked dough-based portion; about 6 wt % of the pre-cooked dough-based portion; or about 5 wt % of the pre-cooked dough-based portion.

In some embodiments, polyols such as glycerine, erythritol, maltitol, and the like may be included in the dough-based portion. In some embodiments, such polyols may be included in order to manipulate the water activity of the dough-based portion. In some embodiments, the water activity of the dough-based portion is manipulated in relation of the water activity of a fat-based portion, such that a driving force for moisture migration between the portions is reduced.

In some embodiments, incorporation of fat in the dough-based portion can enhance the moisture migration barrier properties of the dough-based portion. It is believed that certain fats which may be incorporated into the dough-based portion may partially solidify upon cooling and form a complex with the proteins. Such a structure is believed to discourage moisture migration into the dough-based portion. Suitable fats which may be incorporated into the dough-based portion include those fats which are not pure liquid at room temperature, include but not limited to shortening, palm oil, soybean oil, cottonseed oil, and/or palm kernel oil.

The dough-based portion may be formed by gelatinizing or at least partially gelatinizing a slurry that includes water and flour. In one embodiment, the at least partially gelatinized slurry forms a mass. In one embodiment, the mass is a dough that may be formed directly into the dough-based portion by, for example, sheeting or extrusion or any other known method. In some embodiments, the mass may be combined with other ingredients before forming by sheeting, extrusion, etc.

Dough-Based Portion

In some embodiments, a dough-based portion may be prepared in a process that includes combining flour (e.g., a starch-based flour such as whole wheat flour, enriched flour, corn flour, potato flour, rice flour, oat flour, barley flour, and the like) and water to form a slurry and heating the slurry before baking. In some embodiments, a dough-based portion may be prepared as described in U.S. Patent Application Publication No. 2008/0003340, which is incorporated by reference herein in its entirety. In some embodiments, a dough-based portion may be prepared as described in the U.S. Patent Application Publication No. 2013/0101698, which is incorporated by reference herein in its entirety.

In some embodiments, the slurry includes whole wheat flour, enriched wheat flour, or the like, and combinations thereof. In some embodiments, the amounts of flour and water in the slurry can be adjusted according to the desired consistency and texture of the dough. For example, in some embodiments the ratio of flour to water by weight is about 10:1; about 10:2; about 10:3; about 10:4; about 10:5; about 10:6; about 10:7; about 10:8; about 10:9; about 1:1; about 9:10; about 8:10; about 7:10; about 6:10; or about 5:10. In one embodiment, the ratio of flour to water by weight is about 10:4.7.

In some embodiments, additional ingredients may be included in the slurry based on, for example, desired taste, nutrition, texture, and visual appeal of the dough. In some embodiments, selection of the particular additional ingredients is based upon the response of the particular ingredient to heating of the slurry. For example, in some embodiments additional ingredients to be combined with the slurry are only those ingredients that would not inhibit gelatinization or at least partial gelatinization of the flour within the slurry. Exemplary additional ingredients include, but are not limited to, whole grains, non-whole grains, flavor and/or texture inclusions, dough salt, fiber, protein, colors, fruits, and/or vegetables.

In some embodiments, the ingredients of the slurry are admixed, and the slurry is exposed to heat. In some embodiments, the slurry is exposed to heat at conditions sufficient to gelatinize the flour. In some embodiments, conditions sufficient to gelatinize the flour include a time and temperature effective to gelatinize at least a portion of, and in some embodiments essentially completely, the flour of the slurry. In some embodiments, the slurry is mixed during the heating steps.

In some embodiments, the slurry is exposed to pre-selected temperatures for a pre-selected time in order to impact the textural properties of the finished food-stuff. In some embodiments, the slurry is heated to temperatures based upon the desired gelatinization reaction. For example, the slurry may be heated to the a gelatinization temperature of the slurry. In some embodiments, the gelatinization temperature of the slurry is about 150° F. to about 200° F.; about 155° F. to about 195° F.; about 160° F. to about 190° F.; about 165° F. to about 185° F.; about 170° F. to about 180° F.; about 150° F. to about 180° F., about 155° F. to about 175° F., or about 160° F. to about 170° F. In some embodiments, the gelatinization temperature of the slurry is about 150° F.; about 155° F.; about 160° F.; about 165° F.; about 170° F.; about 175° F.; about 180° F.; about 185° F.; about 190° F.; about 195° F.; or about 200° F.

In some embodiments the slurry is exposed to heat in the form of steam. For example, in some embodiments, the slurry is injected with steam. In some embodiments, the slurry is injected with steam to produce uniform heating of the slurry and gelatinization or at least partial gelatinization. In some embodiments, the steam is introduced at temperatures of about 125° F. to about 240° F.; about 150° F. to about 212° F.; or at about 212° F.

In some embodiments, the slurry is exposed to heat for a duration selected to achieve a particular gelatinization effect. For example, heat may be introduced to the slurry for a period of about 8 minutes to about 20 minutes, or about 10 minutes to about 15 minutes.

In some embodiments, the dough is mixed during the time period that it is exposed to heat (e.g., in the form of steam). In some embodiments the dough is mixed at a rate of about 15 rpm to about 60 rpm; about 20 rpm to about 60 rpm; about 15 rpm to about 25 rpm; about 17 rpm to about 23 rpm; about 19 rpm to about 21 rpm; or about 20 rpm.

In some embodiments, the slurry is exposed to heat by any method or heat source that is effective to achieve the desired gelatinization reaction and result. In some embodiments, the slurry is exposed to heat which is sufficient to produce about 90% to about 100% gelatinization of the flour. For example, suitable forms of heating may include indirect heating, jacket heat, scrape surface heater, heated water, microwave heating, dielectric heating and combinations thereof and the like.

In one embodiment, the gelatinized or at least partially gelatinized slurry forms a mass or dough. The gelatinized mass or dough may have a thicker, more viscous, consistency than the slurry from which it is derived. In one embodiment, the mass is a dough that may be formed directly into the dough-based portion by, for example, sheeting or dough extrusion or any other known method such as those discussed herein. In some embodiments, the mass may be combined with other ingredients before forming by sheeting, extrusion, etc. Examples of such additional ingredients include, but are not limited to, fibers, proteins, cheese, flavors, fruits, veggies, soy pieces, meat pieces, seeds, nuts, specialty whole grains such as quinoa or other inclusions, and combinations thereof

In some embodiments, the pre-baked dough includes flour (e.g., in a slurry such as a water/flour slurry) which was heated (e.g., to gelatinization or e.g., at least partial gelatinization) before baking. In some embodiments, the pre-heated flour makes up about 40 wt % to about 85 wt % of the pre-baked dough; about 40 wt % to about 80 wt % of the pre-baked dough; about 40 wt % to about 75 wt % of the pre-baked dough; about 40 wt % to about 70 wt % of the pre-baked dough; about 45 wt % to about 65 wt % of the pre-baked dough; about 50 wt % to about 60 wt % of the pre-baked dough; at least about 45 wt % of the pre-baked dough; at least about 50 wt % of the pre-baked dough; at least about 54 wt % of the pre-baked dough; about 50 wt % of the pre-baked dough; about 52 wt % of the pre-baked dough; about 54 wt % of the pre-baked dough; about 56 wt % of the pre-baked dough; about 58 wt % of the pre-baked dough; about 60 wt % of the pre-baked dough; at least about 62 wt % of the pre-baked dough; at least about 64 wt % of the pre-baked dough; at least about 66 wt % of the pre-baked dough; about least about 68 wt % of the pre-baked dough; or at least about 70 wt % of the pre-baked dough. In some embodiments, the foregoing percentages reflect an increase moisture content of approximately 2 percent to approximately 3 percent as a result of steam treatment as compared to the percentage prior to steam treatment.

It is believed that the gelatinization of the flour may modify the starch and protein properties of the flour while retaining the functionality of the protein, resulting in unique and desirable characteristics of the dough during or after processing and/or baking. Preparation of a foodstuff according to embodiments of the present invention may allow for incorporation of higher levels of any type of whole grains (such as wheat, corn, rice, barley, oats, and/or multi-grains), added fiber and protein. In some embodiments, whole grains, proteins and fibers are incorporated into a matrix formed during the pre-heating and gelatinizing step, resulting in a more palatable taste and texture than may be otherwise associated with incorporation of such levels of these ingredients. In some embodiments, heating and gelatinizing of the flour slurry before baking the dough allows for incorporation of whole grains, fiber and protein without a grainy, coarse texture and taste in the dough-based portion of the foodstuff which may be otherwise associated with incorporation of such levels of these ingredients.

In some embodiments, heating and gelatinizing of the flour slurry before baking the dough allows for incorporation of inclusions in the dough-based portion, as they are incorporated into a matrix formed during the initial gelatinization step. Such incorporation of the inclusions into a matrix formed during the initial gelatinization step may also allow for thinner sheeting of the dough while maintaining the inclusions within the dough.

In some embodiments, the dough is admixed with additional ingredients after heating and before baking. In some embodiments, additional ingredients, such as sweeteners or flavors, may be included to produce a desired taste. In some embodiments, additional ingredients, such as starch (gelatinized or ungelatinized), may be included to produce a desired texture. In some embodiments, the dough is admixed with ingredients such as, but not limited to, sugar, pre-gelatinized starch, potato starch, and/or additives such as sodium acid pyrophosphate, calcium phosphate monobasic, and/or sodium bicarbonate.

In addition to the foregoing, the doughs employed in some embodiments of the present invention may include other additives conventionally employed in crackers and cookies. Such additives may include, for example, dairy by-products, enzyme modified milk powder, whey, soluble or insoluble edible fiber, such as inulin or other fructooligosaccharides, resistant starch, oat fiber, corn bran, wheat bran, oat bran, rice bran, and soluble polydextrose, egg or egg by-products, cocoa, peanut butter, vanilla or other flavorings, flour substitutes or bulking agents, such as polydextrose, hollocellulose, microcrystalline cellulose, mixtures thereof, and the like, as well as inclusions or particulates such as nuts, raisins, coconut, flavored chips such as chocolate chips, butterscotch chips, white chocolate chips, peanut butter chips, caramel chips, and the like in conventional amounts. In some embodiments, an insoluble fiber such as resistant starch or oat fiber may be employed in the dough. In embodiments of the invention, these additives, such as fiber, chocolate chips or other flavor chips, may be employed in amounts up to about 25% by weight, for example from about 10% by weight to about 20% by weight, based upon the weight of the dough.

A source of protein, which is suitable for inclusion in baked goods, may be included in the doughs of the present invention. In one embodiment, the inclusion of protein promotes Maillard browning. The source of protein may include non-fat dry milk solids, dried or powdered eggs, mixtures thereof, and the like. Also, protein concentrates and isolates from various sources, such as rice, soy, and/or dairy, may be included in the dough-based portion. The amount of the proteinaceous source may, for example, range up to about 20 wt %, based upon the weight of the dough.

The dough compositions of the present invention may contain a leavening system in an amount of up to about 2.5 wt %, based upon the weight of the dough before baking. Exemplary chemical leavening agents or pH-adjusting agents which may be used include alkaline materials and acidic materials such as sodium bicarbonate, ammonium bicarbonate, calcium acid phosphate, sodium acid pyrophosphate, diammonium phosphate, tartaric acid, mixtures thereof, and the like. The leavening agent may include yeast alone or in combination with chemical leavening agents.

Enzymes conventionally used in cracker production, such as amylases and proteases, may be included in the dough in conventional amounts in embodiments of the present invention.

The doughs of the present invention may include antimycotics or preservatives, such as calcium propionate, potassium sorbate, sorbic acid, and the like. Exemplary amounts may range up to about 1% by weight of the dough, to assure microbial shelf-stability. In some embodiments, the dough of the present invention has a low water activity and therefore does not include or require preservatives.

Emulsifiers may be included in effective, emulsifying amounts in the doughs of the present invention. Exemplary emulsifiers which may be used include, mono- and di-glycerides, polyoxyethylene sorbitan fatty acid esters, lecithin, stearoyl lactylates, and mixtures thereof. Exemplary of the polyoxyethylene sorbitan fatty acid esters which may be used are water-soluble polysorbates such as polyoxyethylene (20) sorbitan monostearate (polysorbate 60), polyoxyethylene (20) sorbitan monooleate (polysorbate 80), and mixtures thereof. Examples of natural lecithins which may be used include those derived from plants such as soybean, rapeseed, sunflower, or corn, and those derived from animal sources such as egg yolk. Soybean-oil-derived lecithins are preferred. Exemplary of the stearoyl lactylates are alkali and alkaline stearoyl lactylates such as sodium stearoyl lactylate, calcium stearoyl lactylate, DATEM and mixtures thereof. Exemplary amounts of the emulsifier which may be used range up to about 3% by weight of the dough.

In some embodiments, a dough is admixed with one or more processing aids after heating and before baking. In some embodiments, processing aids may be desirable improve the consistency of the dough for forming, for example, a casing or outer layer of the foodstuff. For example, oil may be admixed to the dough as a processing aid. In addition to providing physical benefits to processing, oil may contribute improved taste to the finished product. Oils useful in the present methods and products may include high oleic canola oil, soybean oil, safflower oil, and/or solid fats such as shortening.

The inclusion of any amount of any additional ingredients, such as those described above, to the dough after heating before baking may be optimized according to the desired taste and texture of the baked dough-based portion. For example, leavening and starch may be included in order to produce a blistering effect of the dough-based portion upon baking.

In some embodiments, the fat content of the dough or baked dough-based portion is less than about 7 wt %; or less than about 5 wt %.

Once all ingredients are incorporated, the dough may be formed into the dough-based portion by, for example, sheeting or dough extrusion or any other known method, as discussed herein. In some embodiments, the dough-based portion exhibits desirable strength characteristics such as elasticity and/or viscosity.

Fat-Based Portion

As discussed above, foodstuffs of the present invention may include a fat-based portion (e.g., a filling). In some embodiments, any edible fat-based portion, including commercially available fillings, may be employed in embodiments of the present invention. The fat-based portion may be savory or sweet. In some embodiments, the fat based filling is a nut butter filling. In some embodiments, a suitable fat-based portion is bake-stable. In some embodiments, a suitable fat-based portion includes a composition and/or method of making a composition as disclosed in U.S. Patent Application Publication No. 2010/0209588 which incorporated herein in its entirety.

In some embodiments, a suitable fat-based portion may be prepared according to any of the following formulations:

TABLE 1
Exemplary Fat-Based Portion Formulations

| | Formulation | | | | |
|---|---|---|---|---|---|
| | 1 | 2 | 3 | 4 | 5 |
| Ingredients | % | % | % | % | % |
| Dairy powders | 31 | 31 | 31 | 28 | 30 |
| Lactose | 19.5 | 18 | 13 | 0 | 0 |
| Vegetable fat | 18 | 18 | 0 | 0 | 0 |
| Vegetable oil | 15 | 15 | 35 | 28 | 28 |
| Starch | 5 | 10 | 5 | 0 | 10 |
| Maltose | 0 | 0 | 0 | 25 | 25 |
| Ground wheat germ | 0 | 0 | 0 | 12 | 0 |
| Calcium sulfate | 5 | 0 | 5 | 0 | 0 |
| Calcium stearate | 3.5 | 5 | 8 | 0 | 0 |
| Acid | 0.5 | 0.5 | 0.5 | 0.1 | 0.1 |
| Salt | 1.5 | 1.5 | 1.5 | 0.5 | 0.5 |
| Flavor | 0.65 | 0.65 | 0.65 | 1.3 | 1.3 |
| Lecithin | 0.3 | 0.3 | 0.3 | 5 | 4 |
| Mono & di glycerides | 0 | 0 | 0 | 0 | 1 |
| Color | 0.05 | 0.05 | 0.05 | 0.1 | 0.1 |
| Total | 100 | 100 | 100 | 100 | 100 |

Another suitable fat-based portion includes Peanut Butter No. 2 Dark Roast, produced by Tara Foods, Albany, Ga.

A fat-based portion suitable for the present invention may have a soft texture. In some embodiments, a fat-based portion maintains its soft texture after baking. In some embodiments, a fat-based portion maintains its soft texture throughout the shelf life of the foodstuff product.

In some embodiments, the fat content of the fat-based portion is about 30 wt % to about 80 wt % of the fat-based portion; about 35 wt % to about 75 wt % of the fat-based portion; about 40 wt % to about 70 wt % of the fat-based portion; about 45 wt % to about 65 wt % of the fat-based portion; about 50 wt % to about 60 wt % of the fat-based portion; about 30 wt % of the fat-based portion; about 35 wt % of the fat-based portion; about 40 wt % of the fat-based portion; about 45 wt % of the fat-based portion; about 50 wt % of the fat-based portion; about 55 wt % of the fat-based portion; about 60 wt % of the fat-based portion; about 65 wt % of the fat-based portion; about 70 wt % of the fat-based portion; about 75 wt % of the fat-based portion; or about 80 wt % of the fat-based portion.

In some embodiments, a suitable filling has a low water activity. In some embodiments, a suitable filling has a water activity of less than about 0.5

In some embodiments, a fat-based portion is bake-stable in that the fat-based portion does not boil during baking.

Assembling

A foodstuff of the present invention may include a dough-based portion and a fat-based portion. Multiple variations of combinations of dough-based portion(s) and fat-based portion(s) are possible. The dough-based portion and the fat-based portion may be combined in the form of a casing and filling respectively. In some embodiments, the filling is not a fat-based filling. The foodstuff of the present invention may also be in the form of a sandwich, an enclosed pocket, a layer of exposed fat-based portion on the dough-based portion, or any other suitable combination of a dough-based portion and a fat-based portion. In some embodiments, the foodstuff may include a dough-based portion which was prepared by heating and gelatinizing before baking, and a dough-based portion which was not heated or gelatinized before baking.

In some embodiments, an assembled foodstuff includes a fat-based portion in an amount of about 10 wt % to about 55 wt % of the assembled foodstuff; about 15 wt % to about 50 wt % of the assembled foodstuff; about 20 wt % to about 45 wt % of the assembled foodstuff; or about 25 wt % to about 40 wt % of the assembled foodstuff. In some embodiments, an assembled foodstuff includes dough-based portion or baked casing in an amount of about 45 wt % to about 90 wt % of the assembled foodstuff; about 50 wt % to about 85 wt % of the assembled foodstuff; about 55 wt % to about 80 wt % of the assembled foodstuff; or about 60 wt % to about 75 wt % of the assembled foodstuff.

Before baking, a fat-based portion may be added to the dough in any suitable manner. In some embodiments, the dough is sheeted or extruded. In some embodiments, the dough is sheeted between conventional, counter-rotating sheeting rolls. In some embodiments, the sheeting rolls may be chilled. The dough may be sheeted by a straight sheeting process by gradually reducing the dough sheet thickness. In some embodiments, the dough may be extruded under low pressure and shear conditions. In some embodiments, dough-based portions prepare as described herein are pliable with film-forming and sheetable properties.

In some embodiments, a fat-based portion is deposited on a layer of dough. In some embodiments, a filling is sandwiched between two layers of dough. In some embodiments, the filling is exposed on the edges of the foodstuff. In some embodiments, the filling is completely enclosed within the dough. In some embodiments, the dough is crimped to partially or completely enclose the filling.

In some embodiments, the filling and dough can be coextruded at low pressure and shear conditions. In some embodiments, the filling and dough may be coextruded in a weight percent ratio of filling to dough of about 10 wt %:90 wt % to about 50 wt %:50 wt %; about 25 wt %:75wt % to about 40 wt %:60 wt %; or about 35 wt %:65 wt %.

In some embodiments, the assembled foodstuff does not include an added barrier layer (e.g., a fat migration barrier, a moisture migration barrier) between the fat-based portion and the dough.

In some embodiments, the assembled foodstuff can be cut before baking. The assembled foodstuff may be cut into any desirable size and shape. In some embodiments, the assembled foodstuff may be cut into squares, such as 1 inch by 1 inch, or sticks, such as 1 inch by 2 inch. Assembled foodstuff may include designs and/or patterned edges such as scalloped edges, or a sin wave design.

Baking

Assembled foodstuff of the present invention may be baked using any suitable oven or conventional method. In some embodiments, assembled foodstuffs are baked at a temperature of about 425° F. to about 525° F., or about 450° F. to about 500° F. In some embodiments, the assembled foodstuffs are baked for about 3 to about 8 minutes, about 4 minutes to about 7 minutes, or about 5 minutes to about 6 minutes.

During baking, the foodstuff may puff up, develop an air pocket between the fat-based portion and a layer of the dough-based portion, and/or develop blistering and layering of the dough-based portion. In some embodiments, layering in the dough-based portion of the baked foodstuff simulates laminated products, even though the dough-based portion was formed by sheeting or extrusion.

In some embodiments, the foodstuffs are baked to produce a foodstuff having a moisture content of about 1% to about 5%; about 1% to about 4%; or about 2% to about 3%.

In some embodiments, after baking, the foodstuff may be dried and/or additional oil and/or salt/seasoning may be applied. Drying may be conducted by any suitable method, including convection or dielectric dryer.

Dual Textured Foodstuff

The baked foodstuff of the present invention may exhibit a dual texture including a crispy dough-based portion, such as a casing, and a soft fat-based portion, such as a filling. In some embodiments, the dough-based portion exhibits a cracker- or pretzel-like texture. In some embodiments, the dual texture is maintained throughout the shelf life of the foodstuff. In some embodiments, a baked foodstuff maintains its dual texture for at least 1 month, for at least 2 months, for at least 3 months for at least 6 months, for at least 1 year and/or for at least 2 years.

In some embodiments, the properties of the foodstuff reduce, slow or substantially prevent migration of fat and/or moisture between the dough-based portion and the fat-based portion in order to maintain the dual texture of the foodstuff. In some embodiments, fat migration between the dough-based portion and the fat-based portion is reduced, slowed or substantially prevented due to unique properties resulting from the heating of the flour slurry, and thereby gelatinizing the starch and denaturing the protein of the flour, before baking the dough. The steps of heating the flour slurry, and thereby gelatinizing the starch and denaturing protein of the flour, before baking the dough may reduce, slow, or substantially prevent fat migration between the dough-based portion and the fat-based portion during baking and/or throughout a shelf-life of the foodstuff. In some embodiments, the fat migration between the dough-based portion and the fat-based portion is reduced, slowed or substantially prevented due to the timing of the contact between the dough-based portion and the fat-based portion, i.e. after the initial heating and gelatinizing of the flour slurry.

In some embodiments, the fat concentration of the fat-based portion of a foodstuff of the present invention remains substantially constant throughout the shelf life of the foodstuff. In some embodiments, the fat concentration of the dough-based portion of a foodstuff of the present invention remains substantially constant throughout the shelf life of the foodstuff. In some embodiments, fat migration between the dough-based portion and the fat-based portion of foodstuffs of the present invention is significantly less than fat migration between a dough-based portion and a fat-based portion of a foodstuff prepared by conventional preparation and baking steps, such as without a heating step before baking (e.g., without steam heating the slurry of flour and water before baking), where the foodstuffs being compared have the same initial fat gradient between the dough-based portion and the fat-based portion. In some embodiments, less than about 1% of the fat concentration of the fat-based portion migrates from the fat-based portion (e.g., to the dough-based portion) during a period of 1 month after baking, 2 months after baking, 3 months after baking, 6 months after baking, 1 year after baking and/or 2 years after baking). In some embodiments, less than about 2% of the fat concentration of the fat-based portion migrates from the fat-based portion (e.g., to the dough-based portion) during a period of 1 month after baking, 2 months after baking, 3 months after baking, 6 months after baking, 1 year after baking and/or 2 years after baking). In some embodiments, less than about 3% of the fat concentration of the fat-based portion migrates from the fat-based portion (e.g., to the dough-based portion) during a period of 1 month after baking, 2 months after baking, 3 months after baking, 6 months after baking, 1 year after baking and/or 2 years after baking). In some embodiments, less than about 4% of the fat concentration of the fat-based portion migrates from the fat-based portion (e.g., to the dough-based portion) during a period of 1 month after baking, 2 months after baking, 3 months after baking, 6 months after baking, 1 year after baking and/or 2 years after baking). In some embodiments, less than about 5% of the fat concentration of the fat-based portion migrates from the fat-based portion (e.g., to the dough-based portion) during a period of 1 month after baking, 2 months after baking, 3 months after baking, 6 months after baking, 1 year after baking and/or 2 years after baking).

In some embodiments, the cooked foodstuff includes a fat migration gradient representing the rate of migration of fat from the cooked fat-based portion (e.g., the cooked filling) to the cooked dough-based portion (e.g., the cooked casing) with which it is in direct contact. In one embodiment the fat migration gradient is approximately zero. In some embodiments, the fat migration gradient is less than approximately 0.1% (measured as a weight percent of the fat in the fat-based portion) per month. In some embodiments, the fat migration gradient is less than approximately 0.2% per month. In some embodiments, the fat migration gradient is less than approximately 0.5% per month. In some embodiments, the fat migration gradient is less than approximately 0.75% per month. In some embodiments, the fat migration gradient is less than approximately 1% per month. In some embodiments, the fat migration gradient is less than approximately 1.25% per month. In some embodiments, the fat migration gradient is less than approximately 1.5% per month. In some embodiments, the fat migration gradient is less than approximately 1.75% per month. In some embodiments, the fat migration gradient is less than approximately 2% per month.

In some embodiments, foodstuffs of the present invention do not include an added barrier layer between the fat-based portion and the dough-based portion. In some embodiments, a dough-based material prepared according to the present invention may be used as a barrier layer between two portions of a product. In some embodiments, a dough-based material prepared according to the present invention may be used as a barrier layer to reduce, slow or substantially prevent fat migration between two products or two portions of a product.

A foodstuff prepared from a dough-based portion and a fat-based portion according to embodiments of the present invention may provide maintenance of oil levels in the fat-based portion during baking and throughout a shelf-life of the foodstuff. Such maintenance of oil levels may allow increased quantity of inclusions in the fat-based portion, a creamier fat-based portion with less fat, and/or the ability to include lower quantities of the fat-based portion while providing the desired taste effect in the foodstuff. Preparation of a foodstuff according to embodiments of the present invention may also allow for the use of a non-aerated filling, while achieving the same reduction in fat migration as might be associated with an aerated filling alone.

Preparation of a foodstuff according to embodiments of the present invention may allow for incorporation of higher levels of whole grains, fiber and protein, or other inclusions for visual appeal. In some embodiments, whole grains, proteins and fibers are incorporated into a matrix formed during the pre-baking heating and gelatinizing step, resulting in a more palatable taste and texture than may be otherwise associated with incorporation of such levels of these ingredients. In some embodiments, heating and gelatinizing of the flour slurry before baking the dough allows for incorporation of whole grains, fiber and protein without a grainy, coarse texture and taste in the dough-based portion of the foodstuff which may be otherwise associated with incorporation of such levels of these ingredients. Preparation of a foodstuff according to embodiments of the present invention may allow for incorporation of higher levels of whole grains, fiber and protein without the effect of drying out the fat-based portion during baking or throughout a shelf-life of the foodstuff.

In some embodiments, a foodstuff is a good source of fiber and/or protein according to the regulations set by the Food and Drug Administration (“FDA”). In some embodiments, a foodstuff is an excellent source of fiber according to the regulations set by the Food and Drug Administration (“FDA”). In some embodiments, a foodstuff includes up to 10% daily value of fiber and/or protein. In some embodiments, a foodstuff includes up to 20% daily value of fiber and/or protein. In some embodiments a foodstuff, includes about 2.5 g fiber per 30 g of foodstuff, or about 5 g fiber per 30 g of foodstuff. In some embodiments, a foodstuff includes about 5 g protein per 30 g of foodstuff, or about 10 g protein per 30 g of foodstuff.

In some embodiments, heating and gelatinizing of the flour slurry before baking the dough allows for incorporation of inclusions in the dough-based portion, as they are incorporated into a matrix formed during the initial gelatinization step.

In some embodiments, the baked dough-based portion includes flour, which was heated to gelatinization before baking, in an amount of about 50 wt % to about 100 wt % of the baked dough-based portion; about 55 wt % to about 95 wt % of the baked dough-based portion; about 60 wt % to about 90 wt % of the baked dough-based portion; about 65 wt % to about 85 wt % of the baked dough-based portion; about 70 wt % to about 80 wt % of the baked dough-based portion; at least about 50 wt % of the baked dough-based portion; at least about 55 wt % of the baked dough-based portion; at least about 60 wt % of the baked dough-based portion; at least about 65 wt % of the baked dough-based portion; at least about 70 wt % of the baked dough-based portion; about 65 wt % of the baked dough-based portion; about 68 wt % of the baked dough-based portion; about 70 wt % of the baked dough-based portion; about 72 wt % of the baked dough-based portion; about 74 wt % of the baked dough-based portion; about 75 wt % of the baked dough-based portion; about 76 wt % of the baked dough-based portion; at least about 78 wt % of the baked dough-based portion; about 80 wt % of the baked dough-based portion; about 82 wt % of the baked dough-based portion; about 85 wt % of the baked dough-based portion; about 90 wt % of the baked dough-based portion; about 95 wt % of the baked dough-based portion; or about 98 wt % of the baked dough-based portion.

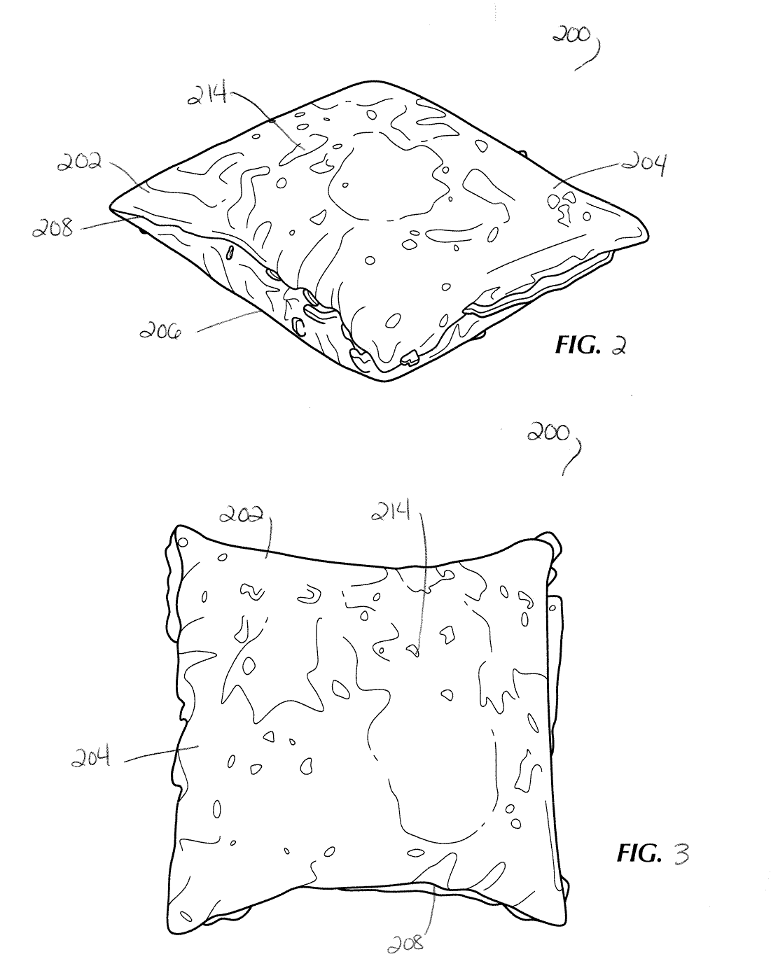

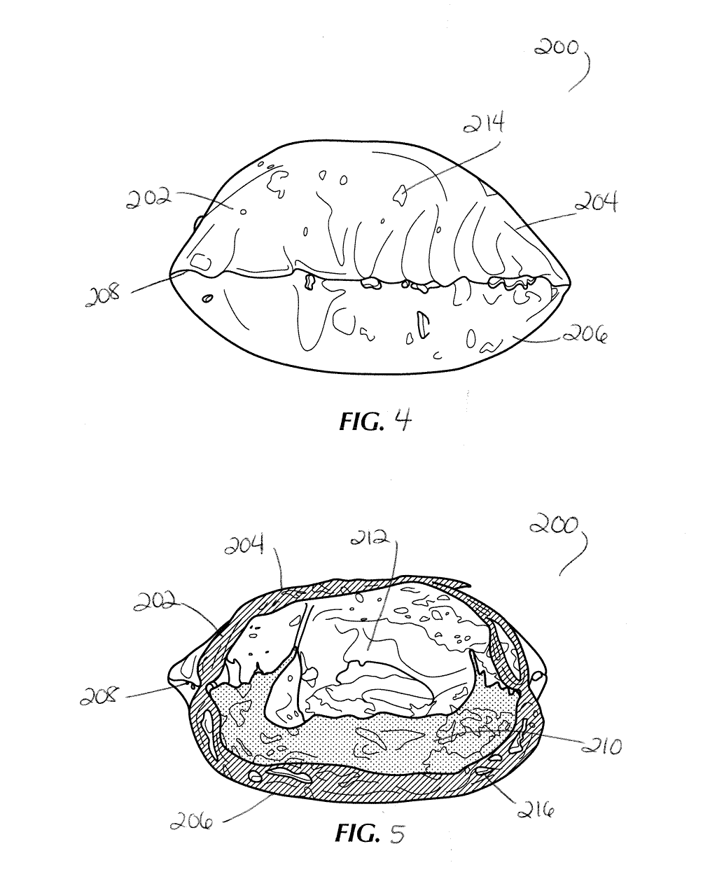

By way of example reference is now made to FIGS. 2-5. Foodstuff 200 may be prepared according to methods described herein. Foodstuff 200 includes dough-based casing 202, with casing top portion 204 and casing bottom portion 206. Dough-based casing 202 has a crispy, crunchy texture, and is prepared according the methods described herein. Casing top portion 204 and casing bottom portion 206 are joined at seam 208, to completely enclose filling 210, as described herein. Filling 210 is bake-stable, and has a soft creamy texture. Foodstuff 200 is assembled prior to baking, according to methods described herein.

As described herein, during baking, foodstuff 200 may puff up to create a rounded, pillow shape. As shown in FIGS. 2-5, after baking, foodstuff 200 exhibits a rounded, pillow shape, with casing top portion 204 and casing bottom portion 206 having convex shapes extending from seam 208. Within baked foodstuff 200, filling 210 rests on bottom casing portion 206. Air pocket 212 is created during baking, and results in a space between casing top portion 204 and filling 210 and/or casing bottom portion 206. During baking, casing 202 may form blistering 214 on the surface or bubbles 216 within casing 202.

### EXAMPLES

### Example 1

### Filled Snack

A dough was prepared from the following ingredients:

| Ingredients | Pounds | Ounces | % of Dough |
|---|---|---|---|
| Group 1 | | | |
| Wheat flour enriched | 75 | 0 | 41.53% |
| Whole wheat flour | 25 | 0 | 13.84% |
| Salt | 0 | 10.4 | 0.36% |
| Water | 45 | 0 | 24.92% |
| Group 2 | | | |
| Pregelatinized corn starch | 14 | 6.4 | 7.97% |
| Sugar | 10 | 6.4 | 5.76% |
| Potato starch | 5 | 4.8 | 2.93% |
| Sodium acid pyrophosphate | 0 | 5.6 | 0.19% |
| Calcium phosphate monobasic | 1 | 4.0 | 0.69% |
| Sodium bicarbonate | 1 | 4.0 | 0.69% |
| Group 3 | | | |
| Oil | 2 | 0 | 1.12% |
| Total | | | 100 |

A filling may be prepared according to Formulations 1-5 described in Table 1 of the Fat-Based Portion section above.

The components of Group 1 of the dough formulation may be mixed in a dough mixer. In order to gelatinize/cook the material, steam may be injected at approximately 150-200° F., while mixing at 20 rpm for 10 to 20 min.

After steaming, the ingredients of Group 2 of the dough formulation may be added to the material in the dough mixer and mixed at 20 rpm for 2 min.

Next, the ingredient of Group 3 of the dough formulation may be added and mixed at 20 rpm for 2 min. After mixing the dough with the ingredient of Group 3, the dough temperature may be between 140° F.-170° F.

The dough may then sheeted on a sheeting line.

The filling may be sandwiched between two sheets of dough. The edges may be crimped such that the filling is completely enclosed within the dough.

The assembled product may then be baked in a direct gas fire or convection or hybrid oven to form a final dual-textured product having 2-3% moisture.

### Example 2

### Oat Dough

A dough may be prepared according to the following formulation:

| Ingredients | Lbs | % |
|---|---|---|
| Whole oat flour | 69.00 | 39.80 |
| Rolled oats | 9.50 | 5.48 |
| Salt | 0.66 | 0.38 |
| Water | 55.00 | 31.72 |
| Parboiled brown rice flour | 24.50 | 14.13 |
| Corn starch | 11.00 | 6.34 |
| Potato starch | 1.00 | 0.58 |
| Calcium phosphate monobasic | 0.26 | 0.15 |
| Sodium bicarbonate | 0.26 | 0.15 |
| Ammonium bicarbonate | 0.20 | 0.12 |
| Safflower oil | 2.00 | 1.15 |
| | 173.380 | 100.00 |

The dough may be prepared by first mixing the oat flour, rice flour, salt, and water at room temperature in a dough mixer to prepare a slurry. The slurry may be gelatinized/cooked by injecting steam to heat the slurry to approximately 170° F.-180° F., while mixing at 20 rpm for 10 to 14 min.

The remaining ingredients (except safflower oil) may be added to the gelatinized/cooked material and mixed at 20 rpm for 2 min.

Safflower oil may then be added to the material and mixed at 20 rpm for 2 min. After this step, the dough temperature may be expected to be about 140° F.-170° F.

The dough may then be sheeted and combined with a filler before baking.

### Example 3

### Dough with Nuts

A dough may be prepared according to the following formulation:

| Ingredients | Lbs | % |
|---|---|---|
| Wheat flour | 65.5 | 30.05 |
| Parboiled brown rice flour | 7.5 | 3.44 |
| Sea Salt | 0.3 | 0.14 |
| Sugar | 2.0 | 0.92 |
| Chopped nuts | 65.0 | 29.82 |
| Corn starch | 8.5 | 3.90 |
| Potato Starch | 8.5 | 3.90 |
| Sodium bicarbonate | 0.25 | 0.11 |
| Calcium phosphate monobasic | 0.25 | 0.11 |
| Ammonium bicarbonate | 0.2 | 0.09 |
| Water | 60.0 | 27.52 |
| TOTAL | 218.0 | 100.00 |

The dough may be prepared by first mixing the wheat four, rice flour, salt, and water at room temperature in dough mixer to form a slurry. The slurry may be gelatinized/cooked by injecting steam to heat the slurry to approximately 170° F.-180° F. while mixing at 20 rpm for 10-14 min.

The remaining ingredients may then be added and mixed at 20 rpm for 2 min. The dough may then be sheeted and combined with a filler, or coextruded with a filler before baking.

### Example 4

### Wheat Cheese Dough

A dough may be prepared according to the following formulation:

| Ingredients | Lbs | % |
|---|---|---|
| Wheat flour | 58.500 | 36.71 |
| Water | 50.000 | 31.37 |
| Parboiled brown rice flour | 24.500 | 15.37 |
| Color | 0.260 | 0.16 |
| Ground paprika | 0.260 | 0.16 |
| Ground red pepper | 0.035 | 0.02 |
| 3 months aged skim milk curd | 5.000 | 3.14 |
| Autolyzed yeast extract powder | 2.000 | 1.25 |
| Aged whole milk cheddar cheese | 3.000 | 1.88 |
| Concentrated enzyme modified cheddar cheese | 1.250 | 0.78 |
| Corn starch | 6.000 | 3.76 |
| Potato starch | 6.000 | 3.76 |
| Salt | 0.440 | 0.28 |
| Calcium phosphate monobasic | 0.660 | 0.41 |
| Sodium bicarbonate | 0.260 | 0.16 |
| Ammonium bicarbonate | 0.200 | 0.13 |
| Safflower oil | 1.000 | 0.63 |
| Total | 159.365 | 100.00 |

The dough may be prepared by first mixing the wheat flour, brown rice flour, salt, and water at room temperature in a dough mixer to form a slurry. The slurry may be gelatinized/cooked by injecting steam to heat the slurry to approximately 170° F.-180° F. while mixing at 20 rpm for 10-14 min.

The remaining ingredients (except safflower oil) may be added to the gelatinized/cooked material and mixed at 20 rpm for 2 min.

Safflower oil may then be added to the material and mixed at 20 rpm for 2 min. After this step, the dough temperature may be expected to be about 140° F.-170° F.

The dough may then be sheeted and combined with a filler, or coextruded with a filler before baking.

### Example 5

### Corn Cheese Dough

A dough may be prepared according the following formulation:

| Ingredients | Lbs | % |
|---|---|---|
| Corn flour | 69.000 | 40.98 |
| Salt | 0.660 | 0.39 |
| Water | 50.000 | 29.69 |
| Parboiled brown rice flour | 24.500 | 14.55 |
| Sugar | 9.500 | 5.64 |
| Corn starch | 11.000 | 6.53 |
| Potato starch | 1.000 | 0.59 |
| Calcium phosphate monobasic | 0.260 | 0.15 |
| Sodium bicarbonate | 0.260 | 0.15 |
| Ammonium bicarbonate | 0.200 | 0.12 |
| Safflower oil | 2.000 | 1.19 |
| Total | 168.380 | 100.00 |

The dough may be prepared by first mixing the corn flour, brown rice flour, salt, and water at room temperature in a dough mixer to form a slurry. The slurry may be gelatinized/cooked by injecting steam to heat the slurry to approximately 170° F.-180° F. while mixing at 20 rpm for 10-14 min.

The remaining ingredients (except safflower oil) may be added to the gelatinized/cooked material and mixed at 20 rpm for 2 min.

Safflower oil may then be added to the material and mixed at 20 rpm for 2 min. After this step, the dough temperature may be expected to be about 140° F.-170° F.

The dough may then be sheeted and combined with a filler, or coextruded with a filler before baking.

### Example 6

### Protein and Fiber Dough

A dough may be prepared according to the following formulation:

| Ingredients | Lbs | % |
|---|---|---|
| Wheat flour | 70 | 36.48 |
| Soy protein | 25 | 13.03 |
| Polydextrose | 15 | 7.82 |
| Salt | 0.66 | 0.34 |
| Corn starch | 12.4 | 6.46 |
| Potato starch | 3.3 | 1.72 |
| Sugar | 8.4 | 4.38 |
| Sodium bicarbonate | 1.25 | 0.65 |
| Calcium phosphate monobasic | 1.25 | 0.65 |
| Diammonium phosphate | 0.37 | 0.19 |
| Ammonium bicarbonate | 1.25 | 0.65 |
| Safflower oil | 3.0 | 1.56 |
| Water | 50 | 26.06 |
| TOTAL | 191.88 | 100.00 |

### Example 7

### Sweet Dough

A dough may be prepared according to the following formulation:

| | LBS | % |
|---|---|---|
| Group 1 | | |
| Wheat flour | 75.00 | 42.54 |
| Whole wheat flour | 25.00 | 14.18 |
| Water | 20.00 | 11.34 |
| Salt | 1.25 | 0.71 |
| Sugar | 21.625 | 12.27 |
| Corn syrup | 2.5625 | 1.45 |
| Honey | 2.50 | 1.42 |
| High fructose corn syrup 42% | 5.625 | 3.19 |
| Molasses sugar cane | 2.50 | 1.42 |
| Group 2 | | |
| Corn starch | 4.00 | 2.27 |
| Potato starch | 4.00 | 2.27 |
| Sodium bicarbonate | 1.25 | 0.71 |
| Calcium phosphate monobasic | 0.25 | 0.14 |
| Ammonium bicarbonate | 0.25 | 0.14 |
| Encapsulated cinnamon powder | 0.50 | 0.28 |
| Group 3 | | |
| Oil | 10.00 | 5.67 |
| TOTAL | 176.31 | 100.00 |

The dough may be prepared by first mixing the components of Group 1 of the dough formulation in a dough mixer to form a slurry. The slurry may be heated in the dough mixer to a temperature of 170° F. to 180° F., while mixing at 20 rpm for 10 to 14 min.

After steaming, the ingredients of Group 2 of the dough formulation may be added to the material in the dough mixer and mixed at 20 rpm for 2 min.

Next, the ingredient of Group 3 of the dough formulation may be added and mixed at 20 rpm for 2 min.

The dough may then be sheeted and combined with a filler, or coextruded with a filler before baking.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

The claims directed to the method of the present invention should not be limited to the performance of their steps in the order written except where expressly stated, and one skilled in the art can readily appreciate that the steps may be varied and still remain within the spirit and scope of the present invention.

We claim:

1. A method for producing a dual-textured foodstuff comprising:
(a) admixing ingredients including flour and water to form a slurry;
(b) exposing the slurry to heat at conditions sufficient to produce a gelatinized dough;
(c) adding a fat-based component to the dough to form a prebaked foodstuff;
(d) baking the prebaked foodstuff to obtain a foodstuff having a dual texture including a baked, fat-based component having a soft texture and a baked dough-based component having a crispy texture.

2. The method of claim 1, further comprising, before the adding a fat-based component to the dough to form a prebaked foodstuff, mixing the gelatinized dough with ingredients including starch.

3. The method of claim 2, wherein the starch comprises potato starch.

4. The method of claim 2, wherein the starch comprises pregelatinized corn starch.

5. The method of claim 2, wherein the ingredients comprise sugar and/or leavening agent.

6. The method of claim 1, further comprising, before the adding the fat-based component to the dough to form a prebaked foodstuff, mixing the dough with ingredients including a processing aid.

7. The method of claim 1, further comprising, before the adding the fat-based component to the dough to form a prebaked foodstuff, forming the dough into a prebaked configuration for accepting the fat-based component.

8. The method of claim 7, wherein the forming the dough includes sheeting the dough into at least two layers and adding the fat-based component between the sheeted dough layers.

9. The method of claim 1, wherein the dough and fat-based component are extruded.

10. The method of claim 1, wherein the heat comprises steam.

11. The method of claim 10, wherein the steam has a temperature of about 212° F.

12. The method of claim 10, wherein the slurry is exposed to the steam for about 10 minutes to about 20 minutes.

13. The method of claim 10, wherein the steam is injected into the slurry.

14. The method of claim 1, wherein the exposing of the slurry to heat is sufficient to produce about 90% to about 100% gelatinization of the flour.

15. The method of claim 1, wherein the flour of the slurry comprises about 70 wt % of the baked dough-based component.

16. The method of claim 1, wherein the flour of the slurry comprises about 75 wt % of the baked dough-based component.

17. The method of claim 1, wherein the flour of the slurry comprises about 80 wt % of the baked dough-based component.

18. The method of claim 1, wherein the fat-based component is completely enclosed within the baked dough-based component.

19. The method of claim 1, wherein the fat-based component comprises a fat content of at least 40 wt %.

20. The method of claim 1, wherein the dough-based component comprises a fat content of less than 5 wt %.

21. The method of claim 1, wherein the foodstuff maintains the dual texture for at least 6 months after baking .

22. The method of claim 1 wherein adding the fat-based component to the dough comprises placing the fat-based component in direct contact with the dough.

23. A dual-textured foodstuff prepared by the method of claim 1.

24. A dual-textured foodstuff comprising:
(a) a baked dough-based component based on a pre-baked heat-treated flour, the baked dough-based component having a first fat concentration and a crispy texture;
(b) a baked fat-based component in direct contact with the baked dough-based component, having a second fat concentration that is higher than the first fat concentration, the baked fat-based component having a soft texture;
wherein the foodstuff exhibits a dual texture comprising a crispy texture of the dough-based component and a soft texture of the fat-based component, and wherein the dual texture is maintained throughout the shelf life of the foodstuff.

25. The foodstuff of claim 24, wherein the pre-baked heat-treated flour comprises at least about 70 wt % of the baked dough-based component.

26. The foodstuff of claim 24 wherein the pre-baked heat-treated flour comprises about 75 wt % of the baked dough-based component.

27. The foodstuff of claim 24, wherein the pre-baked heat-treated flour comprises about 80 wt % of the baked dough-based component.

28. The foodstuff of claim 24, wherein the fat-based component is savory.

29. The foodstuff of claim 24, wherein the fat-based component is sweet.

30. The foodstuff of claim 24, wherein the fat-based component is completely enclosed by the dough-based component.

31. The foodstuff of claim 24, wherein the baked dough-based component comprises a cracker.

32. The foodstuff of claim 24, wherein the first fat concentration is less than 10 wt % and the second fat concentration is greater than 40 wt %.

33. The foodstuff of claim 24, wherein the second fat concentration is greater than the first fat concentration.

34. The foodstuff of claim 24, wherein the first fat concentration is significantly constant throughout the shelf life of the foodstuff.

35. The foodstuff of claim 24, wherein the second fat concentration is significantly constant throughout the shelf life of the foodstuff.

36. The foodstuff of claim 24, wherein the baked dough-based component comprises about 45 wt % to about 90 wt % of the foodstuff.

37. The foodstuff of claim 24, wherein the baked dough-based component comprises about 60 wt % to about 75 wt % of the foodstuff.

38. The foodstuff of claim 24, wherein the fat-based component comprises about 10 wt % to about 55 wt % of the foodstuff.

39. The foodstuff of claim 24, wherein the fat-based component comprises about 25 wt % to about 40 wt % of the foodstuff.

40. A method of producing a baked foodstuff comprising:
forming a first dough layer having a first affinity for fat migration;
forming a gelatinized dough-based fat migration-barrier layer including by admixing ingredients comprising flour and water to form a slurry and exposing the slurry to heat at conditions sufficient to transform the slurry to an at least partially gelatinized dough;
assembling the foodstuff by positioning the gelatinized dough-based fat migration barrier layer between a first dough layer and an edible composition having a fat content that is greater than the fat content of the first dough layer;
baking the pre-baked food stuff to form a baked foodstuff.

41. A dual textured cooked foodstuff comprising:
a crispy cooked dough-based portion based on a steam-treated slurry of water and flour;
a cooked soft fat-based filling in direct contact with the cooked dough portion; and
a fat gradient between the cooked soft fat-based filling and the crispy cooked dough-based portion that is approximately zero.
